(19) United States
(12) Patent Application Publication
(10) Pub. No.: US 2014/0097000 A1
(43) Pub. Date: Apr. 10, 2014

(54) CABLE MANAGEMENT APPARATUS

(71) Applicants: Kao-Yeh LIN, New Taipei (TW); Xin-Hu GONG, Shenzhen (CN)

(72) Inventors: Kao-Yeh LIN, New Taipei (TW); Xin-Hu GONG, Shenzhen (CN)

(21) Appl. No.: 13/684,134

(22) Filed: Nov. 21, 2012

(30) Foreign Application Priority Data
Oct. 10, 2012 (CN) 2012103817481

(51) Int. Cl. H02G 11/00

(52) U.S. Cl. CPC H02G 11/00
USPC 174/135

(57) ABSTRACT

A cable management apparatus includes two mounting brackets, a cable management arm connected between the two mounting brackets and slidable vertically, and two elevating mechanisms respectively mounted between opposite ends of the cable management arm and the corresponding mounting brackets. Each of the elevating mechanisms includes a sliding plate connected to the cable management arm and slidable horizontally relative to the cable management arm, a first connecting pole with opposite ends respectively rotatably connected to the sliding plate and one of the mounting brackets adjacent to the sliding plate, and a second connecting pole with opposite ends respectively rotatably connected to the sliding block and the mounting bracket.

### BACKGROUND

1. Technical Field

The present disclosure relates to a cable management apparatus for electronic equipment.

2. Description of Related Art

Electronic equipment, such as a server, usually includes a chassis and a plurality of functional modules, such as cooling modules, storage modules, and power supply modules, mounted in the chassis. The functional modules are interconnected through cables. Therefore, a cable management apparatus is fastened to a rear end of the chassis to facilitate cable management. However, the cable management apparatus often has to be detached from the chassis when a functional module is inserted into or is removed from the chassis through the rear end of the chassis, which is inconvenient.

### BRIEF DESCRIPTION OF THE DRAWINGS

Many aspects of the present embodiments can be better understood with reference to the drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled, isometric view of an embodiment of a cable management apparatus, an electronic device, and a rack.

FIGS. 2 and 3 each shows an exploded, isometric view of the cable management apparatus of FIG. 1 in different perspectives.

FIG. 4 is assembled view of FIG. 2.

FIG. 5 is a partially enlarged view of FIG. 4.

FIG. 6 is similar to FIG. 1, but showing the cable management apparatus in a different status.

### DETAILED DESCRIPTION

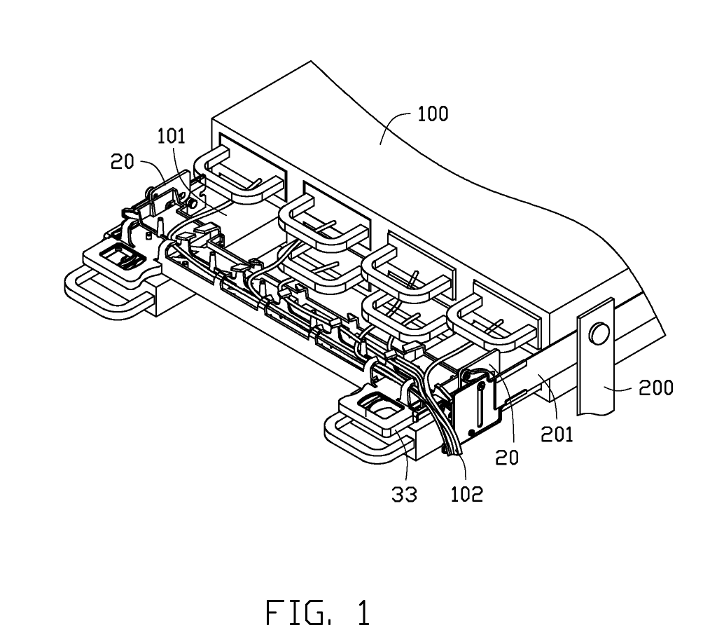

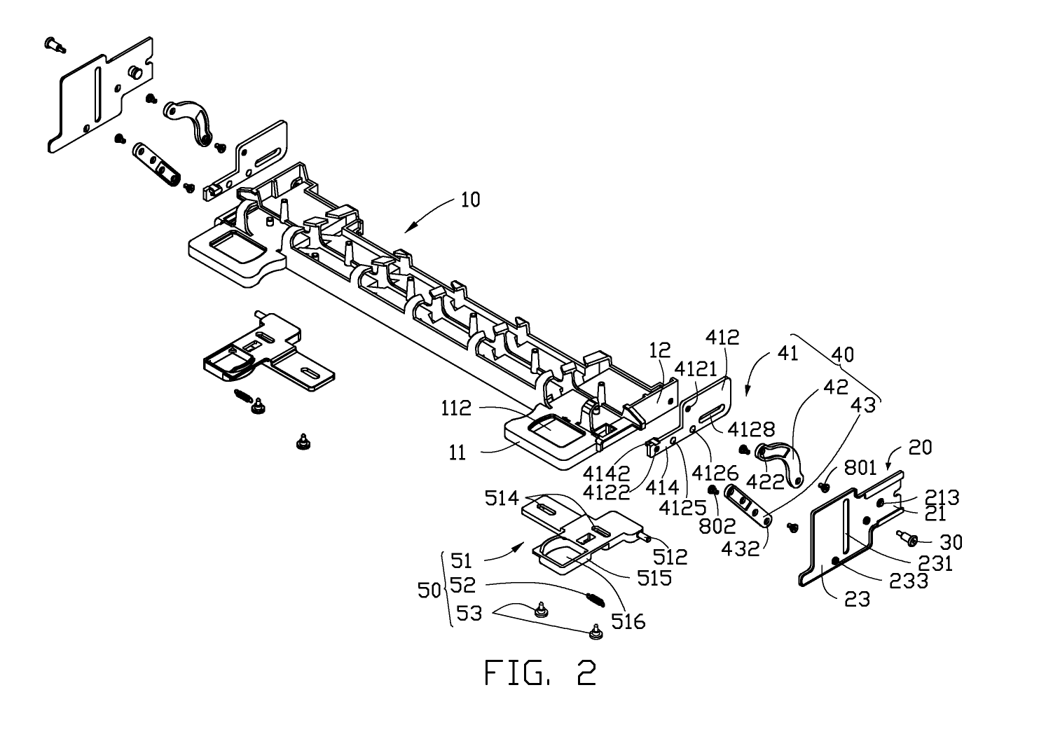

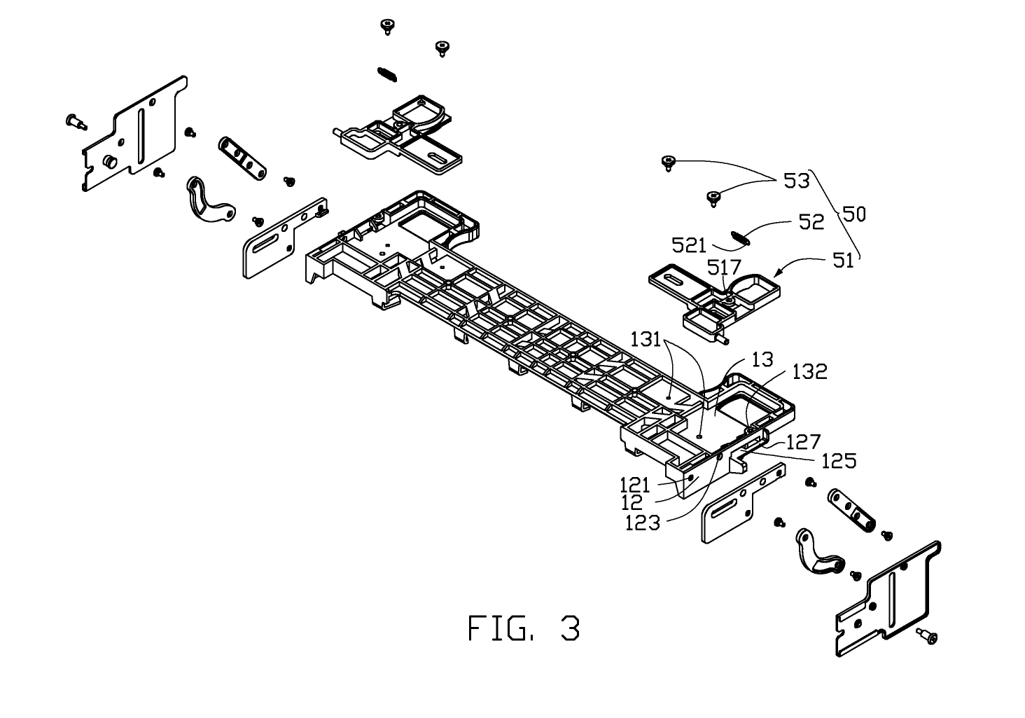

Referring to FIGS. 1-3, an embodiment of a cable management apparatus of the present disclosure is mounted at a rear end of an electronic device 100, such as a server 100. The server 100 is mounted between a pair of rails 201 of a rack 200. The electronic device 100 includes a plurality of functional modules 101, such as power supplies, data storage devices, and cooling modules, which may be drawn from the rear end of the electronic device 100. The able management apparatus is provided to support cables 102 of the functional modules 101. The cable management apparatus includes a cable management arm 10, two mounting brackets 20, two guiding pins 30, two elevating mechanisms 40, and two locking mechanisms 50.

The cable management arm 10 includes two opposite end plates 12 and two handles 11 extending rearwards respectively adjacent to the two end plates 12. Each of the end plates 12 defines a fixing hole 121 adjacent to a front side of the end plate 12, a guiding slot 125 adjacent to a rear side of the end plates 12 and extending horizontally, and a passing hole 123 between the fixing hole 121 and the guiding slot 125. A guiding flange 127 protrudes on each of the end plates 12, and is arranged above and extends along the guiding slot 125. Two accommodating spaces 13 are defined in a bottom of the cable management arm 10, respectively adjacent to the end plates 12. Two fastening holes 131 are defined in the bottom of the cable management arm 10, at each of the two accommodating spaces 13, respectively. Two engagement tabs 132 are formed at the bottom of the cable management arm 10, respectively arranged at the two accommodating spaces 13. Each of the handles 11 defines an interference-avoiding hole 112.

Each of the mounting brackets 20 includes a mounting plate 23, and a fixing plate 21 extending from a side of the mounting plate 23. A fastening member 213 is mounted to the fixing plate 21. The mounting plate 23 defines a vertical slide slot 231. Two inner-threaded standoffs 233 extend from the mounting plate 23, respectively at opposite sides of the slide slot 231.

In the embodiment, the guiding pins 30 are screws.

Each of the elevating mechanisms 40 includes a sliding plate 41, a first connecting pole 42, and a second connecting pole 43. The sliding plate 41 includes a rectangular link portion 412 and a guiding arm 414 extending from a rear side of the link portion 412. The link portion 412 defines a horizontal slide slot 4128. The sliding plate 41 defines a first mounting hole 4121 in the link portion 412 adjacent to a top-rear corner of the link portion 412 and a second mounting hole 4122 in a distal end of the guiding arm 414 far away from the link portion 412. The sliding plate 41 further defines a first locating hole 4125 in a middle of the guiding arm 414 and a second locating hole 4126 in the link portion 412 adjacent to the guiding arm 414. A hook 4142 extends from a top of the distal end of the guiding arm 414. The first connecting pole 42 is substantially C-shaped, and defines two pivot holes 422 respectively in opposite ends of the first connecting pole 42. The second connecting pole 43 is bar-shaped, and defines two pivot holes 432 respectively in opposite ends of the second connecting pole 43.

Each of the locking mechanisms 50 includes a locking member 51, a resilient member 52, and two positioning pins 53. A locking pin 512 extends from a side of the locking member 51. The locking member 51 defines two slide slots 514 extending in parallel to an axis of the locking pin 512. The locking member 51 includes a trigger 515 defining a finger receiving hole 516. An engagement tab 517 is formed at a bottom of the locking member 51. In one embodiment, the resilient member 52 is a coil spring 52, with two hooks 521 extending from opposite ends of the resilient member 52.

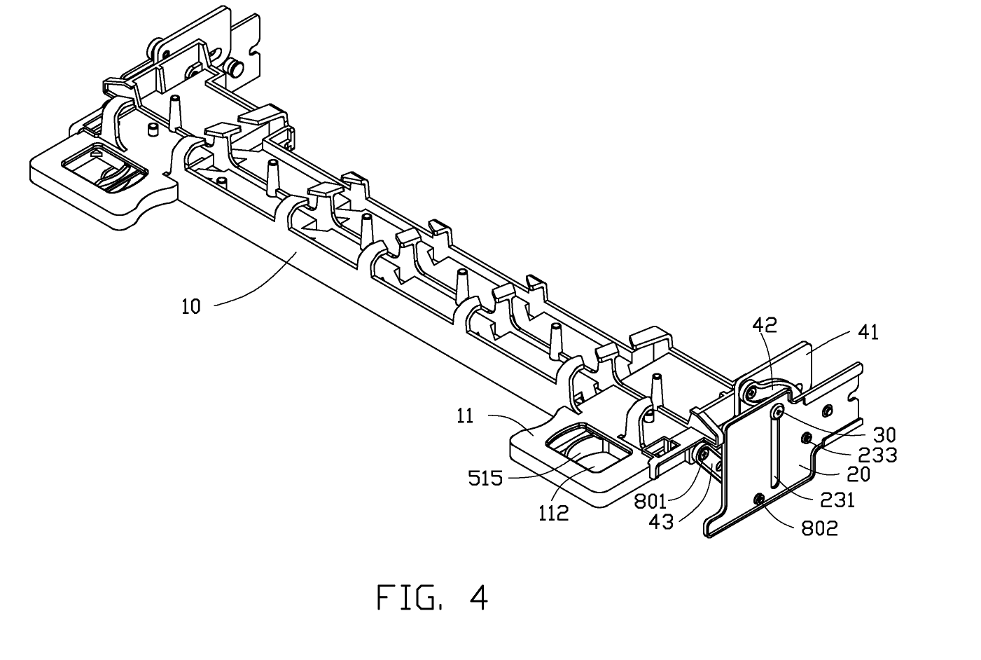

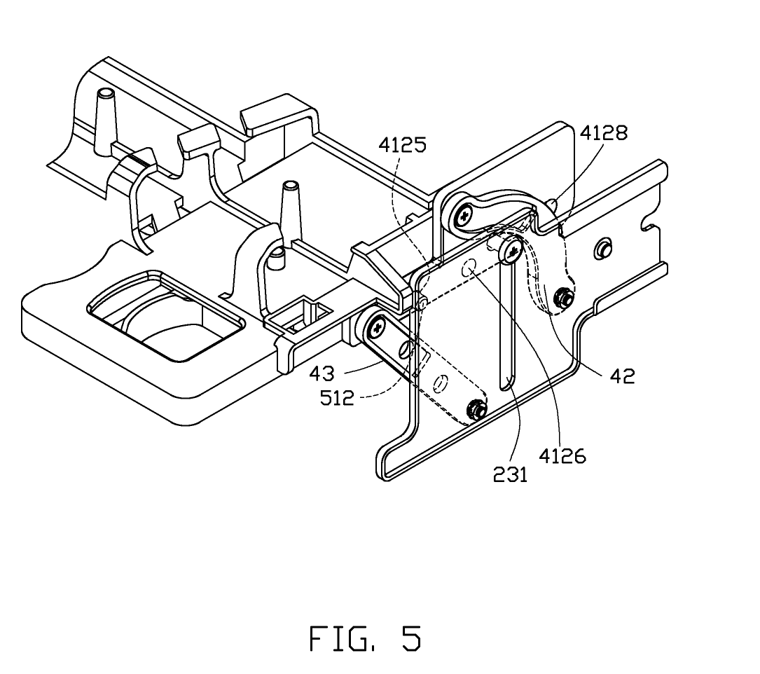

Referring to FIGS. 4 and 5, in assembly, one of the mounting brackets 20, one of the guiding pins 30, one of the elevating mechanisms 40, and one of the locking members 50 are mounted to each of opposite ends of the cable management arm 10.

The locking member 51 is received in a corresponding accommodating space 13 of the cable management arm 10, with the locking pin 512 of the locking member 51 extending through a corresponding passing hole 123 of the cable management arm 10. The slide slots 514 of the locking member 51 are aligned with the corresponding fastening holes 131 of the cable management arm 10. The positioning pins 53 slidably extend through the slide slots 514 and are fastened in the corresponding fastening holes 131, to slidably mount the locking member 51 to the bottom of the cable management arm 10. The resilient member 52 are mounted to the bottom of cable management arm 10, with the hooks 521 of the resilient member 52 respectively engaging with the engagement tab 517 of the locking member 51 and a corresponding engagement tab 132 of the cable management arm 10. The finger receiving hole 516 of the locking member 51 is aligned with a corresponding interference-avoiding hole 112 of the cable management arm 10.

A screw 801 extends through one of the pivot holes 422 of the first connecting pole 42 and is fastened in the first mounting hole 4121 of the sliding plate 41. Another screw 801 extends through one of the pivot holes 432 of the second connecting pole 43 and is fastened in the second mounting hole 4122 of the sliding plate 41. Therefore, the first and second connecting poles 42 and 43 are pivotably connected to the sliding plate 41. The sliding plate 41 abuts an outside of a corresponding end plate 12. The guide arm 414 is arranged below the guiding flange 127, with the hook 4142 of the guide arm 414 slidably engaging in the guiding slot 125 of the end plate 12, to slidably mount the sliding plate 41 to the cable management arm 10. The locking pin 512 of the locking member 51 engages in the first locating hole 4125 of the sliding plate 41 to fix the sliding plate 41 in place. The slide slot 4128 of the sliding plate 41 is aligned with the fixing hole 121 of the end plate 12. The guiding pin 30 extends through the slide slot 231 of the mounting bracket 20 and the slide slot 4128 of the sliding plate 41, and is fastened in the fixing hole 121 of the end plate 12, to slidably mount the cable management arm 10 to the mounting bracket 20. Two screws 802 respectively extend through the other pivot hole 422 of the first connecting pole 42 and the other pivot hole 432 of the second connecting pole 42, and are correspondingly fastened in the two standoffs 233, to pivotably connecting the first and second connecting poles 42 and 43 to the mounting bracket 20.

Referring to FIG. 1, the cable management apparatus is mounted to the rear end of the electronic device 100, by correspondingly fixing the mounting brackets 20 to the rails 201 with the fastening members 213. The cable management arm 10 is fixed at a first locating position adjacent to a top of the electronic device 100, to provide a space for drawing the functional module 101 arranged at the lower portion of the electronic device 100.

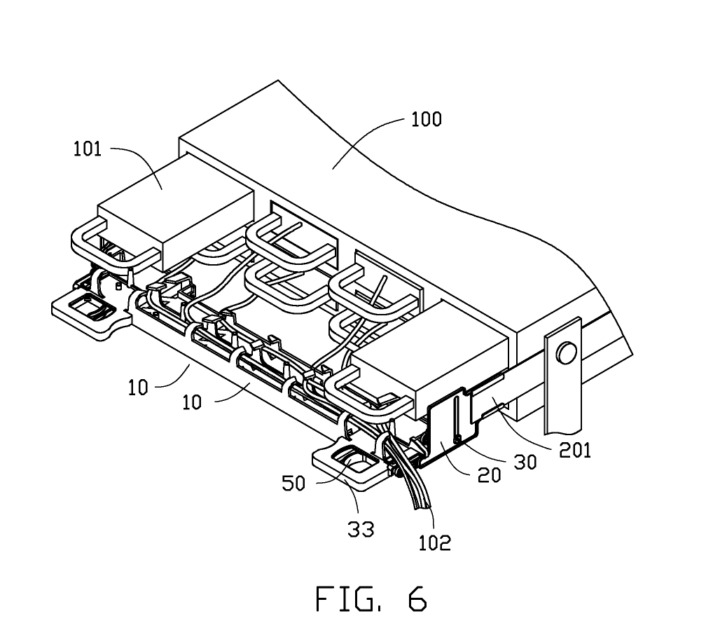

Referring to FIG. 6, when one of the functional modules 101 arranged at an upper portion of the electronic device 100 needs to be drawn, the triggers 515 are pressed through the interference-avoiding holes 112 of the cable management arm 10, to move the two locking members 51 towards each other until the locking pins 512 disengage from the first locating holes 4125 of the corresponding sliding plates 41. The resilient members 52 are deformed. The cable management arm 10 is moved down with the sliding plates 41. The first and second connecting poles 42 and 43 are rotated downwards. With the sliding of the sliding plates 41 and the rotation of the first and second connecting poles 42 and 43, the sliding plates 41 slide rearwards relative to the cable management arm 10 until the second locating holes 4126 of the sliding plates 41 are aligned with the locking pins 512 of the corresponding locking members 51. The resilient members 52 are restored to bias the two locking members 51 away from each other to engage in the second locating holes 4126 to stop the sliding of the sliding plates 41. At that time, the cable management arm 10 is fixed at a second locating position adjacent to a bottom of the electronic device 100, to provide a space for drawing the functional module 101 arranged at the upper portion of the electronic device 100.

It is to be understood, however, that even though numerous characteristics and advantages of the present disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A cable management apparatus for cables of an electronic device, comprising:
two mounting brackets respectively fixed to opposite sides of the electronic device and extending out of an end of the electronic device;
a cable management arm mounted between the two mounting brackets; and
two elevating mechanisms respectively mounted between one of opposite ends of the cable management arm and a corresponding one of the two mounting brackets, each of the elevating mechanisms comprising:
a sliding plate slidably attached to one of the opposite ends of the cable management arm in a horizontal direction;
a first connecting pole comprising opposite ends rotatably connected to the mounting bracket and the sliding plate, respectively; and
a second connecting pole comprising opposite ends rotatably connected to the mounting bracket and the sliding plate, respectively.

2. The cable management apparatus of claim 1, further comprising two guiding pins, wherein each of the mounting brackets defines a vertical slide slot, the guiding pins slidably engage in the slide slots of the mounting brackets and are fixed to the opposite ends of the cable management arm.

3. The cable management apparatus of claim 2, wherein the cable management arm comprises two opposite end plates, each end plate defines a horizontal guide slot, each of the sliding plates comprises a hook slidably engaging in the guiding slot of one of the mounting brackets, the guiding pins are correspondingly fixed to the end plates.

4. The cable management apparatus of claim 2, wherein ends of the first and second poles of each of the elevating mechanisms fixed to the corresponding mounting brackets are arranged at opposite sides of the slide slot of the mounting bracket.

5. The cable management apparatus of claim 1, further comprising two locking mechanisms mounted to the cable management arm, respectively adjacent to the mounting brackets, wherein each of the locking mechanisms comprises a locking member slidably connected to the corresponding mounting bracket, and a locking pin, wherein each of the sliding plates defines a first locating hole and a second locating hole, the cable management arm is fixed at a first locating position adjacent to a top of the electronic device in response to the locking pins of the locking members engaging in the first locating holes of the corresponding sliding plates; the cable management arm is fixed at a second locating position adjacent to a bottom of the electronic device in response to the locking pins of the locking members engaging in the second locating holes of the corresponding sliding plates.

6. The cable management apparatus of claim 5, wherein each of the locking mechanisms further comprises a resilient member connected between the locking member and the cable management arm.

7. The cable management apparatus of claim 6, wherein each of the resilient members is a coil spring with two hooks extending from opposite ends of the resilient member, the hooks receptively engage with an engagement tab of the cable management arm and an engagement tab of the locking member.

8. The cable management apparatus of claim 6, wherein the cable management arm comprises two handles adjacent to opposite ends of the cable management arm, each of the handles defines an interference-avoiding hole, each of the locking members comprises a trigger aligned with the interference-avoiding hole of one of the handles.

9. The cable management apparatus of claim 5, wherein the cable management arm defines two accommodating spaces in a bottom of the cable management arm, respectively adjacent to the opposite ends of the cable management arm; two fastening holes are defined in the bottom of the cable management arm, at each of the two accommodating spaces, each of the locking mechanisms is received in one of the accommodating spaces and defines two slide slots; and each of the locking mechanisms further comprises two positioning pins extending through the slide slots of the corresponding lock mechanisms and fastened in the corresponding fastening holes of the cable management arm.
